(19) United States
(12) Patent Application Publication
(10) Pub. No.: US 2012/0290789 A1
(43) Pub. Date: Nov. 15, 2012

(54) PREFERENTIALLY ACCELERATING APPLICATIONS IN A MULTI-TENANT STORAGE SYSTEM VIA UTILITY DRIVEN DATA CACHING

(75) Inventors: Sai Ramakrishna Susarla, Bangalore (IN); Brian McKean, Longmont, CO (US)

(73) Assignee: LSI CORPORATION, Milpitas, CA (US)

(21) Appl. No.: 13/106,542

(22) Filed: May 12, 2011

(51) Int. Cl. G06F 12/08

(52) U.S. Cl. 711/118; 711/E12.017

(57) ABSTRACT

A system may include multi-tenant electronic storage for hosting a plurality of applications having heterogeneous Input/Output (I/O) characteristics, relative importance levels, and Service-Level Objectives (SLOs). The system may also include a management interface for managing the multi-tenant electronic storage, where the management interface is configured to receive a storage resource arbitration policy based on at least one of a workload type, an SLO, or a priority for an application. The system may further include control programming configured to receive an association of a particular I/O stream with a particular application generating the I/O stream, where the association of the I/O stream with the application was determined by analyzing at least one I/O characteristic of the I/O stream, and determine at least one of a cache size or a caching policy for the application based on the association of the I/O stream with the application and the storage resource arbitration policy.

### TECHNICAL FIELD

The present disclosure generally relates to the field of electronic storage, and more particularly to a system and method for preferentially accelerating applications in a multi-tenant storage system via utility driven data caching.

### BACKGROUND

Electronic storage systems routinely cache recently accessed data to provide a faster response time for that data, should the data be needed to satisfy a subsequent request. Cache for these storage subsystems is typically stored on Random Access Memory (RAM) semiconductor technology. Some storage systems use other tiers of data storage in order to optimize systems for performance or cost. For example, Solid State Storage (SSS) based on flash memory technology may be utilized as a medium to store information that can be accessed much faster than information stored on Hard Disk Drives (HDD). Cache management routines typically contain mechanisms to track use of data. These mechanisms may include a list of data blocks accessed, kept in Least Recently Used (LRU) order.

One problem with caching approaches to improve performance in a storage system may occur when the amount of data that is frequently accessed through the storage system, called its “working set,” is larger than the amount of data that can fit into the higher performance cache or tier. When this happens, often the mechanisms that improve performance with smaller data sets begin to degrade performance due to “thrashing” of data into and out of the higher performance cache. Another factor that affects application performance is the logic to determine which blocks to retain in the cache and when to evict them, called the cache replacement policy.

Different applications utilizing electronic storage systems as part of their execution may have different working sets and optimal replacement schemes based on their data access characteristics. Moreover, data center applications may differ in their relative importance to a business, their performance, and service-level objectives, such as response time and throughput. When such applications compete for a limited data cache that cannot capture all of their hot data, a cache that employs a uniform working set and replacement policy can often yield sub-optimal performance to all applications, because it allocates more resources to applications that do not need them, thereby starving other, possibly more important, applications.

### SUMMARY

The present disclosure is directed to a system and method for preferential acceleration of applications in a multi-tenant storage system via utility-driven data caching. A system may include multi-tenant electronic storage for hosting a plurality of applications having heterogeneous Input/Output (I/O) characteristics, relative importance levels, and Service-Level Objectives (SLOs). The system may also include a management interface for managing the multi-tenant electronic storage, where the management interface is configured to receive a storage resource arbitration policy based on at least one of a workload type, an SLO, or a priority for an application. The system may further include control programming configured to receive an association of a particular I/O stream with a particular application generating the I/O stream, where the association of the I/O stream with the application was determined by analyzing at least one I/O characteristic of the I/O stream, and determine at least one of a cache size or a caching policy for the application based on the association of the I/O stream with the application and the storage resource arbitration policy.

A method for preferentially accelerating selected applications in a multi-tenant storage system having limited caching resources may include using a computer or processor to perform the steps of hosting a plurality of applications having heterogeneous Input/Output (I/O) characteristics, relative importance levels, and Service-Level Objectives (SLOs), where the plurality of applications generates a plurality of I/O streams. The method may also include receiving a storage resource arbitration policy based on at least one of a workload type, an SLO, or a priority for an application. The method may further include receiving an association of a particular I/O stream with a particular application generating the I/O stream, where the association of the I/O stream with the application was determined by analyzing at least one I/O characteristic of the I/O stream. The method may also include determining at least one of a cache size or a caching policy for the application based on the association of the I/O stream with the application and the storage resource arbitration policy.

A method for preferentially accelerating selected applications in a multi-tenant storage system having limited caching resources may include using a computer or processor to perform the steps of hosting a plurality of applications having heterogeneous Input/Output (I/O) characteristics, relative importance levels, and Service-Level Objectives (SLOs), where the plurality of applications generates a plurality of I/O streams. The method may also include receiving a storage resource arbitration policy based on at least one of a workload type, an SLO, or a priority for an application. The method may further include receiving an association of a particular I/O stream with a particular application generating the I/O stream, where the association of the I/O stream with the application was determined by analyzing at least one I/O characteristic of the I/O stream. The method may also include determining at least one of a cache size or a caching policy for the application by computing a bias factor for a particular cache block utilized by the application based on the association of the I/O stream with the application and the storage resource arbitration policy.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a schematic illustrating an architectural context for a multi-tenant storage system for hosting heterogeneous applications;

FIG. 2 is a graph illustrating SLO headroom versus observed latency for an application hosted by a multi-tenant storage system;

FIG. 3 is a schematic illustrating SLO performance for multiple applications hosted by a multi-tenant storage system; and

FIG. 4 is a flow diagram illustrating a method for accelerating selected applications in a multi-tenant storage system having limited caching resources.

### DETAILED DESCRIPTION

Reference will now be made in detail to the subject matter disclosed, which is illustrated in the accompanying drawings.

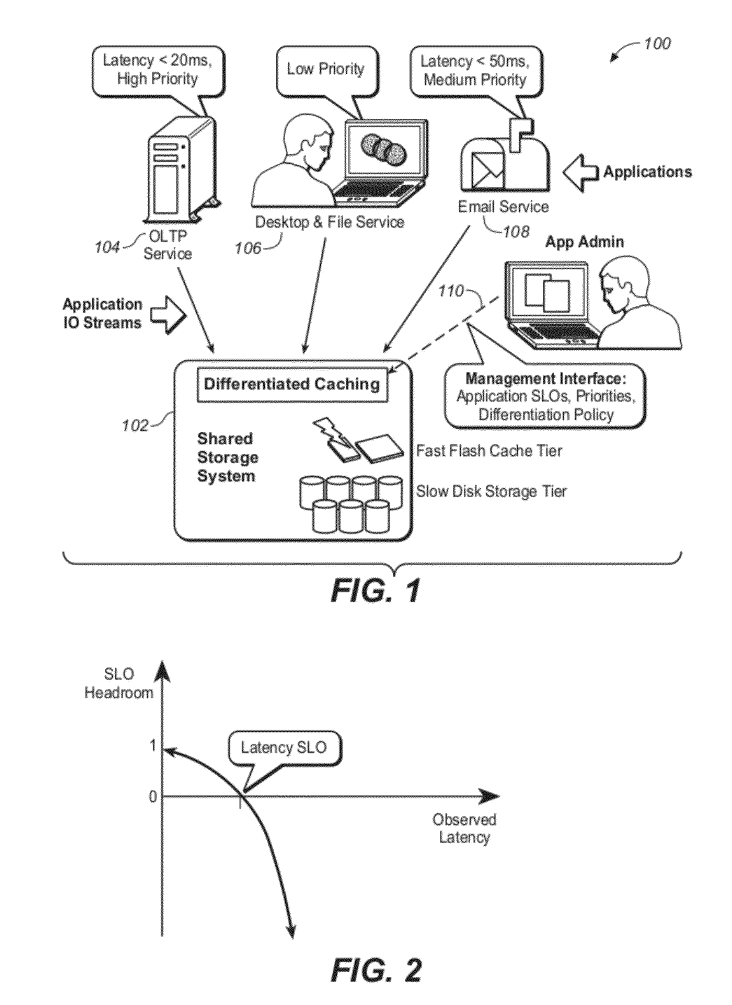

Referring generally to FIGS. 1 through 4, a system and method for preferentially accelerating selected applications in a multi-tenant storage system having limited caching resources, and intelligently allocating shared caching resources among competing applications by exploiting I/O characteristics is described. The system and method of the present disclosure may be implemented with electronic storage systems including, but not limited to, external, internal/Direct-Attached Storage (DAS), RAID, Network-Attached Storage (NAS), and Storage Area Network (SAN) systems and/or networks. However, this list is provided by way of example only, and is not meant to limit the present disclosure.

Multi-tenancy storage refers to a storage system that simultaneously hosts data belonging to multiple unrelated applications. Sharing helps amortize the system's cost over multiple applications by improving the overall asset utilization. An important challenge in designing multi-tenancy storage systems lies in meeting the performance requirements of the various tenants, while maximizing the utility of the limited storage system resources, especially processors and various levels of data caches. Because data caching resources may be expensive to provision in large quantities to accommodate all applications, efficiently sharing data caching resources in multi-tenancy storage may significantly improve application responsiveness.

Not all application workloads benefit equally from caching at a faster storage tier. This is due to their different working sets and access patterns. Assigning cache shares proportionately to applications based on their priority alone may cause the caching resource to be utilized sub-optimally. For instance, some applications may underutilize their share while others are starved. Thus, the actual cache usage and its benefit should be considered in addition to relative priorities when assigning caching resources to applications.

A typical cache management algorithm ranks the objects to be cached in faster storage by their popularity, and tends to keep more popular objects in the cache by evicting less popular ones. An application's working set denotes its set of frequently accessed (i.e., popular) objects. The intuition is that popular objects contribute more to overall application performance, and accelerating their access improves overall performance. Existing caching algorithms may be utilized to detect popularity indirectly via access counts in a recent interval of time. This information may then be utilized as the basis for caching decisions.

In some instances, techniques may be utilized to determine, at runtime, an appropriate amount of cache and a cache replacement policy that is well suited for a given storage workload with specific characteristics. However, employing these techniques in a multi-tenancy storage system requires knowledge of the application type for incoming I/O streams and their service-level requirements to enable the caching subsystem to treat them differently. Requiring an application designer to manually tag an application's I/O stream with the application type may be cumbersome and impractical.

A technique has been developed to automatically infer from an application's I/O request stream observed at the storage interface, the type of application workload, its host operating system, and a file system generating the I/O which may achieve greater than 95% accuracy. Workload types that can be identified include enterprise workloads, such as email, Online Transaction Processing (OLTP), data warehousing, file-based operations, and virtual desktops. This technique is described in the following publication, which is herein incorporated by reference in its entirety: Neeraja J. Yadwadkar, Chiranjib Bhattacharyya, K. Gopinath, Thirumale Niranjan, and Sai Susarla. Discovery of Application Workloads from Network File Traces. In Proceedings of the 8th USENIX Conference on File and Storage Technologies (FAST'10). USENIX Association, 2010.

Referring now to FIG. 1, a system 100 is described. The system 100 may include multi-tenant electronic storage, such as a shared storage system 102. The shared storage system 102 may serve a number of applications having heterogeneous Input/Output (I/O) characteristics, relative importance levels, and Service-Level Objectives (SLOs), i.e., I/O characteristics, importance levels, and/or SLOs that are not all the same. For instance, the shared storage system 102 may host a set of applications including an OLTP service application 104, a desktop and file service application 106, and/or an Email service application 108. In embodiments, each application I/O stream may be tagged with information including, but not necessarily limited to, the type of its workload (which may change over time), its performance SLO (throughput and latency), and its SLO priority relative to other application I/O streams.

The system 100 may include a management interface 110 for allowing an operator, such as a system administrator, or the like, to specify application SLOs, priorities, and/or differentiation policy for the various applications hosted by the shared storage system 102. For example, the management interface 110 may be utilized to specify a storage resource arbitration policy based on workload type, stream SLOs, and/or their priorities. Example policies may include “prioritize OLTP over file service workloads”, “maximize SLO adherence”, and “accommodate the most applications”, among others. In an embodiment, an SLO differentiation policy interface external agent may be implemented to determine prioritization of performance, and to set SLOs of some applications above or below others.

The management interface 110 may be configured to receive an association of a particular I/O stream with a particular application generating the I/O stream. For example, a particular I/O stream may be identified with the OLTP service application 104. In an embodiment, the association of an I/O stream with an application is determined by analyzing one or more I/O characteristics of the I/O stream, as described in the previously-referenced publication. The management interface 110 may then determine working set sizes for various applications utilizing associations of I/O streams with their corresponding applications. For instance, a bookkeeping method/utility function may be utilized to efficiently compute the working sets of multiple I/O streams online. In an embodiment, SLO differentiation may be utilized to detect applications' I/O streams by analyzing I/O characteristics. Then, working set size analysis of the detected application I/O streams may be utilized to determine optimal cache size, and modify caching policies to meet SLOs of more important applications at the expense of the rest.

In an embodiment, the management interface 110 may include an implementation of a method/utility function to rank the quality of service delivered to various applications, factoring in I/O stream SLOs, relative priorities, and the resource arbitration policy. For example, resource arbitration by priority may assign faster storage, such as memory and solid-state drives, to selectively accelerate the performance of higher priority applications. Alternatively, resource arbitration by priority and utility may assign faster/more expensive storage to applications that may benefit the most based on their I/O characteristics. For example, a set of higher priority applications may be chosen to cache in order to maximize system performance and minimize negative effects such as cache thrashing.

Further, the management interface 110 may include an analysis mechanism to determine how much share of a cache to give to each stream to maximize the utility function described above. For instance, caching benefit analysis may be utilized on an ongoing basis to analyze the detected application I/O streams to determine streams that could improve performance if allocated additional cache, or maintain performance with a reduction in allocated cache. Additionally, caching effectiveness of multiple applications may be tracked online based on analyzing their I/O characteristics.

Competing application aspects may be considered when establishing a storage resource arbitration policy for cache management. Within the context of the present disclosure, SLO headroom refers to how much an application's performance is above its minimum goal, or SLO. For example, when SLO headroom is negative, an application may require more cache share. Alternatively, when SLO headroom is positive, an application may safely yield its share to other applications. Priority refers to how important an application's performance is perceived (e.g., by a network administrator) relative to other applications. For instance, a more important application requires a larger cache share, provided it is not meeting its SLO. In an embodiment, priority may be defined by an integer greater than or equal to one, where higher numbers indicate higher priority. Working set/popularity refers to the set of objects that contribute to the bulk of application accesses. It should be noted that different applications may have overlapping sets of popular objects. In implementations, object popularity and application importance may favor moving application storage objects into faster storage tiers, while higher SLO headroom may favor moving application storage objects into slower storage tiers.

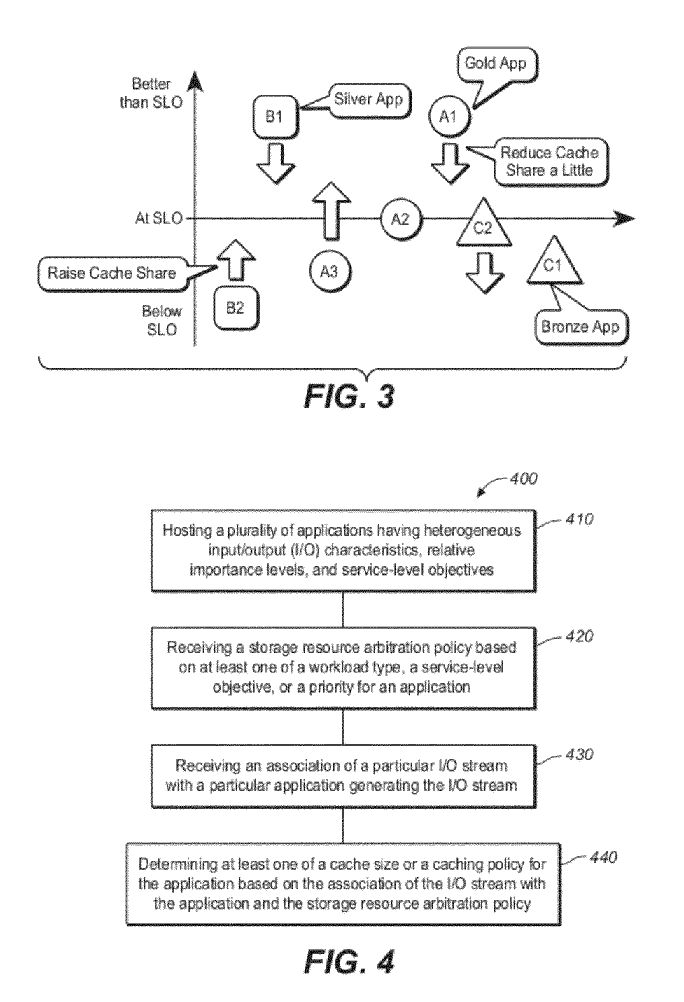

Referring now to FIG. 2, the SLO headroom function may be designed to vary with application performance. In the example illustrated in the accompanying figure, the SLO headroom measure is seen to rapidly decay as the response time (latency) decreases beyond the application's SLO. Referring to FIG. 3, an illustration of how cache share of applications may be biased based upon their relative importance and current performance is described. In the accompanying example, applications A1, A2, and A3 require the highest priority, while applications C1 and C2 require the least priority. To improve the performance of B2 and A3, B1's cache share is reduced more than A1's cache share, though both have an equal amount of headroom. A3 is given more of that cache share than B2. C1's cache share is not increased, though it could utilize more cache. In the present example, A2 is just meeting its SLO.

In an embodiment, cache blocks Bᵢ stored by the shared storage system 102 may be ranked in decreasing order of preference for caching as follows:

Rank(Bᵢ)=access count(Bᵢ)*app_bias(Bᵢ)

where an application bias factor, app_bias, is computed for a cache block as described below. First, it may be determined how well each application is faring against its SLO utilizing a performance metric M, such as latency and/or throughput. For instance, the following computation may be utilized with metrics where a lower value is considered better:

SLO_headroom_{latency}=1−(Latency_{current}/Latency_{SLO})^{app}^{_{—}}^{priority}

Alternatively, the following computation may be utilized with metrics where a higher value is considered better:

SLO_headroom_{throughput}=1−(Throughput_{SLO}/Throughput_{current})^{app}^{_{—}}^{priority}

In the preceding formulas, Latency_{current} and Throughput_{current} indicate the moving average or 90th percentile values of those metrics for a given application I/O stream over time. Thus, they indicate the recent performance delivered to the application stream. In this example, an SLO_headroom value of zero indicates that the application is just meeting its SLO. The value asymptotically approaches one as the application performs better than its SLO. A negative value indicates that its SLO is being violated proportionately. This relationship may be seen in FIG. 2. It will be appreciated that utilizing the application's priority value as an exponent to the metric ratio heavily penalizes violations of the SLOs of higher priority applications. Thus, it encourages caching higher priority application data when the application's SLO is not being met.

Next, the normalized SLO headroom for an application I/O stream A may be computed as a weighted sum of the headroom across all metrics of interest:

SLO_headroom(A)=(ΣWeight_{M}*SLO_headroom_{M} over all metrics M)

In the present example, by assigning weights to metrics (which indicate their relative importance for an application) such that their sum equals one, the SLO_headroom(A) may be represented as a number between one and minus infinity, having the same meaning as its metric-specific counterpart.

Next, the app_bias of a caching candidate block Bᵢ may be computed as follows:

App_bias(Bᵢ)=−ΣSLO_headroom(Aⱼ)

over all application I/O streams Aⱼ that accessed Bᵢ in the recent past. This computation is designed to boost a block's priority for caching based on the combined importance of applications that need it.

Thus, some consequences of this ranking methodology include the following. When SLOs are specified for application streams, if their SLOs are being met or exceeded, caching is discouraged for their blocks regardless of their relative priority. Alternatively, caching is strongly encouraged for applications facing SLO violations (more so for higher priority applications). It should be noted that when no SLOs are specified for some applications, an artificial SLO target may be greedily set closer to the in cache performance, so that applications will benefit from the available caching resources in proportion to their priority. When multiple application I/O streams share the same cache blocks, those blocks will be preferred more for caching than unshared blocks. FIG. 3 illustrates how these decisions may be implemented in an example scenario with seven applications of various priorities and performance levels, as previously described.

In an embodiment, the metadata for each cache entry may include the following information: pointers for cache block lookup in hash table; pointers for cache ordering (typically LRU); flags; hit tracking; and cache block information, which may include volume, start Logical Block Address (LBA) of cache block, valid sectors in cache block, and/or newly written (dirty) sectors in cache block. Further, the metadata for each cache history metadata entry may include the following information: pointers for cache block lookup in hash table; pointers for history list ordering (typically LRU); number of hits; system block counter value at time of last hit; delta blocks transferred since last hit; and cache block information, which may include volume, start LBA of cache block, and valid sectors in cache block.

Referring now to FIG. 4, a method 400 for preferentially accelerating selected applications in a multi-tenant storage system having limited caching resources is described. The method 400 may include using a computer or processor to perform the steps of hosting a plurality of applications having heterogeneous Input/Output (I/O) characteristics, relative importance levels, and Service-Level Objectives (SLOs), where the plurality of applications generate a plurality of I/O streams, 410. The method 400 may also include receiving a storage resource arbitration policy based on at least one of a workload type, an SLO, or a priority for an application, 420. The method may further include receiving an association of a particular I/O stream with a particular application generating the I/O stream, where the association of the I/O stream with the application was determined by analyzing at least one I/O characteristic of the I/O stream, 430. The method may also include determining at least one of a cache size or a caching policy for the application based on the association of the I/O stream with the application and the storage resource arbitration policy, 440.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A system, comprising:
multi-tenant electronic storage for hosting a plurality of applications having heterogeneous Input/Output (I/O) characteristics, relative importance levels, and Service-Level Objectives (SLOs), the plurality of applications generating a plurality of I/O streams;
a management interface for managing the multi-tenant electronic storage, where the management interface is configured to receive a storage resource arbitration policy based on at least one of a workload type, an SLO, or a priority for an application;
control programming configured to:
receive an association of a particular I/O stream with a particular application generating the I/O stream, where the association of the I/O stream with the application was determined by analyzing at least one I/O characteristic of the I/O stream; and
determine at least one of a cache size or a caching policy for the application based on the association of the I/O stream with the application and the storage resource arbitration policy.

2. The system of claim 1, wherein the at least one of the cache size or the caching policy is determined by computing a bias factor for a particular cache block utilized by the application.

3. The system of claim 2, wherein the bias factor is computed based upon at least one of a latency or a throughput for the I/O stream associated with the application.

4. The system of claim 3, wherein the at least one of the latency or the throughput for the I/O stream associated with the application is determined by at least one of a moving average or a 90th percentile value.

5. The system of claim 2, wherein the bias factor is computed based upon an exponential computation utilizing a priority for the application.

6. The system of claim 2, wherein the cache block utilized by the application is also utilized by a second application, and where the bias factor is computed based upon a priority for the application and a priority for the second application.

7. The system of claim 1, where an SLO for the application is set at least substantially at a level of in cache performance when the SLO is not specified via the management interface.

8. A method for preferentially accelerating selected applications in a multi-tenant storage system having limited caching resources, comprising:
using a computer or processor to perform the steps of
hosting a plurality of applications having heterogeneous Input/Output (I/O) characteristics, relative importance levels, and Service-Level Objectives (SLOs), the plurality of applications generating a plurality of I/O streams;
receiving a storage resource arbitration policy based on at least one of a workload type, an SLO, or a priority for an application;
receiving an association of a particular I/O stream with a particular application generating the I/O stream, where the association of the I/O stream with the application was determined by analyzing at least one I/O characteristic of the I/O stream; and
determining at least one of a cache size or a caching policy for the application based on the association of the I/O stream with the application and the storage resource arbitration policy.

9. The method of claim 8, wherein determining at least one of a cache size or a caching policy based on the association of the I/O stream with the application and the storage resource arbitration policy comprises:
computing a bias factor for a particular cache block utilized by the application.

10. The method of claim 9, wherein computing a bias factor for a particular cache block utilized by the application comprises:
computing the bias factor based upon at least one of a latency or a throughput for the I/O stream associated with the application.

11. The method of claim 10, wherein the at least one of the latency or the throughput for the I/O stream associated with the application is determined by at least one of a moving average or a 90th percentile value.

12. The method of claim 9, wherein the bias factor is computed based upon an exponential computation utilizing a priority for the application.

13. The method of claim 9, wherein the cache block utilized by the application is also utilized by a second application, and where the bias factor is computed based upon a priority for the application and a priority for the second application.

14. The system of claim 8, further comprising:
setting an SLO for the application at least substantially at a level of in cache performance when the SLO is not specified via the management interface.

15. A method for preferentially accelerating selected applications in a multi-tenant storage system having limited caching resources, comprising:
using a computer or processor to perform the steps of
hosting a plurality of applications having heterogeneous Input/Output (I/O) characteristics, relative importance levels, and Service-Level Objectives (SLOs), the plurality of applications generating a plurality of I/O streams;
receiving a storage resource arbitration policy based on at least one of a workload type, an SLO, or a priority for an application;
receiving an association of a particular I/O stream with a particular application generating the I/O stream, where the association of the I/O stream with the application was determined by analyzing at least one I/O characteristic of the I/O stream; and
determining at least one of a cache size or a caching policy for the application by computing a bias factor for a particular cache block utilized by the application based on the association of the I/O stream with the application and the storage resource arbitration policy, where the cache block utilized by the application is also utilized by a second application, and where the bias factor is computed based upon the priority for the application and a priority for the second application.

16. The method of claim 15, wherein computing a bias factor for a particular cache block utilized by the application comprises:
computing the bias factor based upon at least one of a latency or a throughput for the I/O stream associated with the application.

17. The method of claim 16, wherein the at least one of the latency or the throughput for the I/O stream associated with the application is determined by at least one of a moving average or a 90th percentile value.

18. The method of claim 15, wherein the bias factor is computed based upon an exponential computation utilizing a priority for the application.

19. The system of claim 15, further comprising:
setting an SLO for the application at least substantially at a level of in cache performance when the SLO is not specified via the management interface.
